(19) United States
(12) Patent Application Publication
(10) Pub. No.: US 2023/0302731 A1
(43) Pub. Date: Sep. 28, 2023

(54) PROJECTION DEVICE WITH COMBINED MATRIX OPTICAL LENS AND 3D PRINTER

(71) Applicant: Shenzhen Anlun Optical Co., LTD, Shenzhen (CN)

(72) Inventors: Jianyu HUANG, Shenzhen (CN); Yan YANG, Shenzhen (CN)

(21) Appl. No.: 17/723,327

(22) Filed: Apr. 18, 2022

(30) Foreign Application Priority Data
Mar. 23, 2022 (CN) 2022206477527

(51) Int. Cl. B29C 64/282; B29C 64/286; B33Y 30/00; B29C 64/129

(52) U.S. Cl. CPC B29C 64/282; B29C 64/286; B33Y 30/00; B29C 64/129

(57) ABSTRACT

A projection device with a combined matrix optical lens and 3D printer is disclosed. The LED array includes multiple rows and columns of point light sources; the combined matrix optical lens includes a first and second matrix optical lenses, wherein the first matrix optical lens consists of the first lenses with the same arrangement and the same number as the point light source, the second matrix optical lens consists of the second lenses with the same arrangement and the same number as the point light source; the 385-405 nm ultraviolet light emitted by the point light source passes through the corresponding first lens and the corresponding second lens in turn and is projected to the LCD liquid crystal display. The device adopts the combined matrix optical lens, which improves the uniformity of the light spot, and it is helpful for the 3D printer to improve the printing success rate and efficiency.

This patent application claims the benefit and priority of Chinese Patent Application No. 202220647752.7 filed on Mar. 23, 2022, the disclosure of which is incorporated by reference herein in its entirety as part of the present application.

### TECHNICAL FIELD

The present disclosure relates to the technical field of UV light curing 3D printers and 3D printing, in particular to a projection device with a combined matrix optical lens and 3D printer.

### BACKGROUND ART

At present, there are three types of photocurable 3D printers, SLA (stereo lithography appearance), DLP (digital light processing), LCD (liquid-crystal display) and other technical molding machines. The method used in SLA technology is to irradiate the photosensitive resin with a laser. In this method, the laser G code is used to scan the laser of each model layer one by one from point to line, and then the photosensitive resin fast laser is irradiated by the laser. The light source of DLP technology application comes from projector. The projector irradiates the model part as a plane image into the resin solution for solidification. The projector irradiates the model part as a plane image into the resin solution for solidification. With this method, the surface is formed once, and the printing time only depends on the height of the object to be printed. LCD photo-curing 3D printer has the advantages of high precision and cheap equipment. UV curing has an important application in 3D printing, which mainly uses ultraviolet light to scan the surface of liquid photosensitive resin, each time a thin layer with a certain thickness is generated, and objects are generated layer by layer from the bottom, and the 3D printing of UV curing is completed through the transformation of polymer from liquid to solid.

Now, in the LCD technology, the UV light curing 3D printer, the current problems in the industry are: the monolithic matrix array optical lens can only converge the LED light once (light energy passing through a lens is called “primary convergence”), the light energy of the LED is refracted by the monolithic matrix array optical lens, and the luminous angle is large, which leads to the low uniformity of the whole light spot formed by the refraction of the monolithic matrix array optical lens, and the uneven light energy leads to low precision, so that rapid printing cannot be realized (if the uniformity of the light energy projected onto the exposure screen is insufficient, the light energy of 385˜405 nm received in the liquid resin box will vary, resulting in the decrease of printing accuracy; printing time of parts with low light energy is prolonged), at the same time, the light energy refracted by a single matrix array optical lens has weak ability to pass through LCD (large-angle light energy will be partially blocked by black-and-white LCD, which is not conducive to high light efficiency), so the utilization rate of light energy is low. Moreover, there is a problem that the monolithic matrix array optical lens is too thick to be injection molded.

In addition, the UV curing of 3D printers needs to realize high-precision printing through high-uniform light energy and precise parallel light, therefore, in order to achieve the high-precision and fast printing effect of the whole machine, the requirements for the uniformity and small angle of the whole spot are the technical problems that the technicians in this field need to solve urgently.

### SUMMARY

A main object of the present disclosure is to provide a projection device with a combined matrix optical lens and 3D printer which at least partially solve the above technical problems.

To achieve the above objective, the technical scheme adopted by the present disclosure is as follows:

In a first aspect, an embodiment of the present disclosure provides a projection device with a combined matrix optical lens, wherein the device includes an LED array arranged along the light path in sequence from bottom to top, a combined matrix optical lens and a LCD liquid crystal display;

the LED array includes multiple rows and columns of point light sources and the point light sources are UV ultraviolet LED chips;

the combined matrix optical lens includes a first matrix optical lens and a second matrix optical lens arranged along an optical path in this order from bottom to top, wherein the first matrix optical lens is composed of a first lens with the same arrangement and the same number as the point light source, the second matrix optical lens is composed of the second lenses with the same arrangement and the same number as the point light source, and a position of the point light source coincides with a focal point of the corresponding first lens and the corresponding second lens at the same time;

the 385-405 nm ultraviolet light emitted by the point light source passes through the corresponding first lens and the corresponding second lens in turn and is projected to the LCD liquid crystal display.

Preferably, the LED array further includes a circuit board, and the multiple UV ultraviolet LED chips are all cured on the circuit board;

the circuit board is fixed on the radiator;

the first matrix optical lens is connected to the radiator at the same time and covers the circuit board, so as to be located above multiple UV ultraviolet LED chips;

the radiator is also connected with a bracket, the second matrix optical lens is fixed on the bracket, and the bracket is provided with the multiple light holes, wherein, the positions of the multiple light holes correspond to the positions of the multiple first lenses one by one at the same time, and simultaneously correspond to the positions of the multiple second lenses one by one.

Preferably, an LED with 50% light intensity angle of 60° or 90° is selected in the UV ultraviolet LED chip.

Preferably, the circuit board is an aluminum substrate or a copper substrate.

In a second aspect, an embodiment of the present disclosure also provides a 3D printer, a projection device with a combined matrix optical lens as described in any one of the above embodiments.

As can be seen from the above technical solution, compared with the prior art, the present disclosure provides a projection device with a combined matrix optical lens and a 3D printer, which can realize the following technical effects:

The 385-405 nm ultraviolet light emitted by the point light source is projected to the LCD panel after two convergences (the light energy passing through a lens is called “one convergence”), therefore, the 385-405 nm ultraviolet light emitted by the point light source can be refracted by the corresponding first lens and second lens in turn to form parallel light or nearly parallel light energy with a left-right angle of less than 1.5 degrees (light emitting angle is small) and then projected to the LCD liquid crystal display screen, moreover, the uniform light energy distribution of 385˜405 nm can be obtained on the LCD liquid crystal display screen 3 (the measured uniformity of the optical machine can reach more than 90%). Therefore, the printing accuracy and printing efficiency are improved, and at the same time, the ability of light energy to pass through the black-and-white LCD is improved (small-angle light energy is not easy to be partially blocked by the black-and-white LCD, which is favorable for obtaining high light efficiency), so that the application can obtain higher light energy utilization rate.

### BRIEF DESCRIPTION OF THE DRAWINGS

FIG. 1 is a structural schematic diagram of a projection device with a combined matrix optical lens provided by the present disclosure;

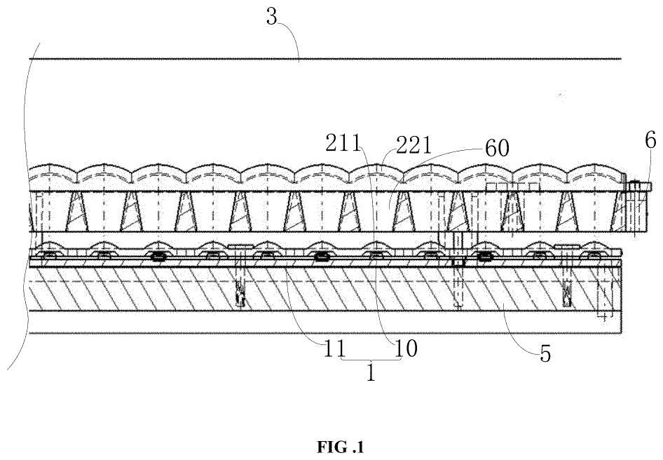

FIG. 2 is a schematic structural diagram of a combined matrix optical lens provided by an embodiment of the present disclosure;

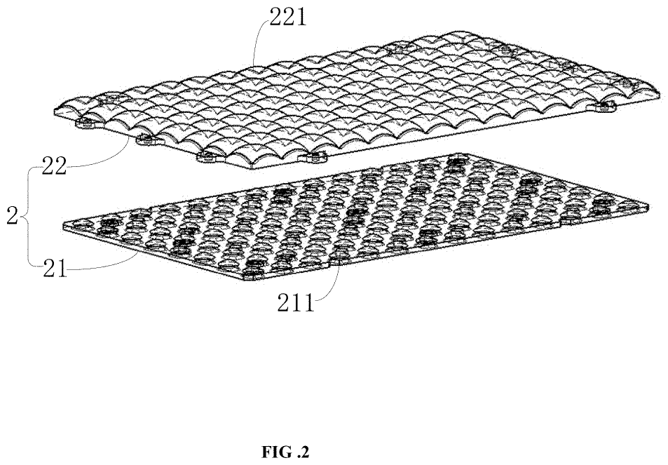

FIG. 3 is a side view of an LED array provided by an embodiment of the present disclosure;

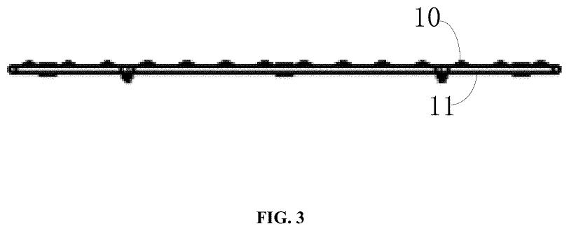

FIG. 4 is a top view of a bracket provided by an embodiment of the present disclosure;

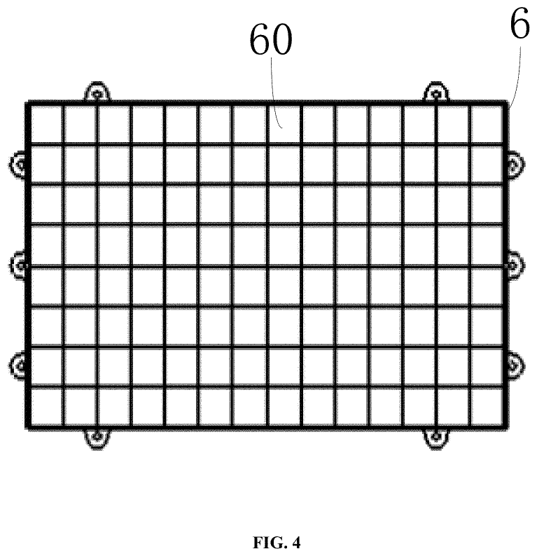

FIG. 5 is a schematic diagram of an optical path provided by the present disclosure;

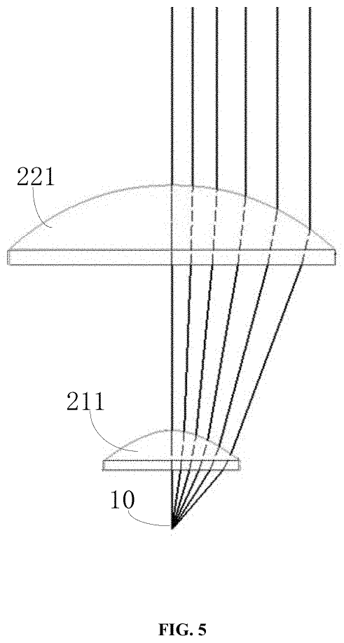

FIG. 6 is a simulation effect diagram obtained by light simulation using Monte Carlo method after optical design provided by the present disclosure;

FIG. 7 is an effect diagram of light energy distribution on the whole exposure screen provided by the present disclosure;

wherein: 1—the LED array; 10—the point light source; 2—the combined matrix optical lens; 3—the LCD liquid crystal display; 21—the first matrix optical lens; 22—the second matrix optical lens; 211—the first lens; 221—the second lens; 11—the circuit board; 5—the radiator; 6—the bracket; 60—the light hole;

### DETAILED DESCRIPTION OF THE EMBODIMENTS

In order to make the technical means, creative features, achievement purpose and efficacy of the present disclosure easy to understand, the present disclosure will be further explained below in combination with specific embodiments.

In the description of the present disclosure, it should be noted that the azimuth or positional relationship indicated by the terms “upper”, “lower”, “inner”, “outer” front end”, “back end”, “two ends”, “one end” and “the other end” is based on the azimuth or positional relationship shown in the drawings, which is only for convenience of describing the present disclosure and simplifying the description, rather than indicating or implying what is indicated. In addition, the terms “first” and “second” are used for descriptive purposes only, and cannot be understood as indicating or implying relative importance.

In the description of the present disclosure, it should be noted that the terms “installation”, “installation” and “connection” should be broadly understood, for example, “connection” can be a fixed connection, a detachable connection or an integral connection, unless otherwise specified and limited; it may be a mechanical connection or an electrical connection; it can be directly connected, it can be indirectly connected through an intermediate medium, it can be the connection between the two elements. For ordinary technicians in the field, the specific meanings of the above terms in the present disclosure can be understood in specific situations.

### Embodiment 1

A projection device with a combined matrix optical lens, including: an LED array 1 arranged along the light path in sequence from bottom to top, a combined matrix optical lens 2 and a LCD liquid crystal display 3;

the LED array 1 includes multiple rows and columns of point light sources 10 and the point light sources 10 are UV ultraviolet LED chips;

the combined matrix optical lens 2 includes a first matrix optical lens 21 and a second matrix optical lens 22 arranged along an optical path in this order from bottom to top, wherein the first matrix optical lens 21 is composed of a first lens 211 with the same arrangement and the same number as the point light source 10, the second matrix optical lens 22 is composed of the second lenses 221 with the same arrangement and the same number as the point light source 10, and a position of the point light source 10 coincides with a focal point of the corresponding first lens 211 and the corresponding second lens 221 at the same time;

the 385-405 nm ultraviolet light emitted by the point light source 10 passes through the corresponding first lens 211 and the corresponding second lens 221 in turn and is projected to the LCD liquid crystal display 3.

In the present application, the position of the point light source 10 coincides with the focal points of the corresponding first lens 211 and the second lens 221 (firstly, the combined collimating lens is designed according to the Snell's law of the light, and the propagating direction of the incident light and the refracted light is determined when the light passes through the interface of the two media, the plane formed by the incident light ray and the interface normal through the incident point is called the incident surface, and the angle between the incident light ray and the refracted light ray and the normal is called the incident angle and the refracted angle, which are expressed by θi and θt, respectively, in the incident plane, the ratio of sine of incident angle to refraction angle is a constant, and the refractive index is represented by n: sin θi/sin θt=n the focal point of the combined matrix optical lens of the 3D UV curing light source is coincident with the point light source 10 of 385˜405 nm, thus generating parallel light). At the same time, the 385-405 nm ultraviolet light emitted by the point light source 10 is projected to the LCD liquid crystal display 3 through the corresponding first lens 211 and the second lens 221 in turn, that is, the 385-405 nm ultraviolet light emitted by the point light source 10 is projected to the LCD liquid crystal display 3 after being converged twice (the light energy passes through a lens and is called “primary convergence”). Therefore, the 385-405 nm ultraviolet light emitted by the point light source 10 can be refracted by the corresponding first lens 211 and the second lens 221 in turn to form parallel light or nearly parallel light energy with a left-right angle of less than 1.5 degrees (light emitting angle is small) and then projected to the LCD liquid crystal display 3. In addition, a uniform light energy distribution of 385-405 nm can be obtained on the LCD liquid crystal display 3 (the measured light machine uniformity is more than 90%), thereby improving the printing accuracy and printing efficiency, at the same time, the ability of light energy passing through the black-and-white LCD is improved (small angle light energy is not easily blocked by the black-and-white LCD, so it is beneficial to obtain high light efficiency), so that the application can obtain higher light energy utilization ratio.

In addition, since the 385-405 nm ultraviolet light emitted by the point light source 10 of the present application is sequentially projected to the LCD liquid crystal display 3 through the corresponding first lens 211 and the second lens 221, compared with the conventional monolithic matrix lens, under the same requirement, the thickness of the first lens 211 and the thickness of the second lens 221 are both reduced, so that the injection precision of the lens can be controlled better.

UV ultraviolet LED chip (UV ultraviolet LED chip is the prior art), which has long life, no heat radiation, no influence of opening and closing times on its life, high energy and uniform irradiation to improve production efficiency, it has the advantage of being free of toxic substances, which is safer and more environmentally friendly than the conventional array of point sources.

In order to further optimize the above technical solution, the LED array 1 further includes a circuit board 11, and the multiple UV ultraviolet LED chips are all cured on the circuit board 11;

the circuit board 11 is fixed on the radiator 5;

the first matrix optical lens 21 is connected to the radiator 5 at the same time and covers the circuit board 11 so as to be located above a plurality of the UV ultraviolet LED chips;

the radiator 5 is also connected with a bracket 6, the second matrix optical lens 22 is fixed on the bracket 6, and the bracket 6 is provided with the multiple light holes 60, wherein, the positions of the multiple light holes 60 correspond to the positions of the multiple first lenses 211 one by one at the same time, and simultaneously correspond to the positions of the multiple second lenses 221 one by one.

In this application, the radiator 5 dissipates heat, and at the same time provides support for the circuit board 11, the first matrix optical lens 21 and the bracket 6, meanwhile, the second matrix optical lens 22 is supported by the bracket 6, so that the second matrix optical lens 22 can be positioned above the first matrix optical lens 21, in addition, the multiple light holes 60 corresponding to the positions of the first lenses 211 pass through the holder 6, and the positions of the light holes 60 correspond to the positions of the second lenses 221, then, the light emitted from the UV LED chip can pass through the corresponding first lens 211, the corresponding light hole 60 and the corresponding second lens 221 and then be displayed to the LCD panel 3, so as to avoid the bracket 6 from affecting the normal propagation of the light path.

Wherein, the structure and principle of the multiple UV ultraviolet LED chips all cured on the circuit board 11 are prior art, and are not described herein.

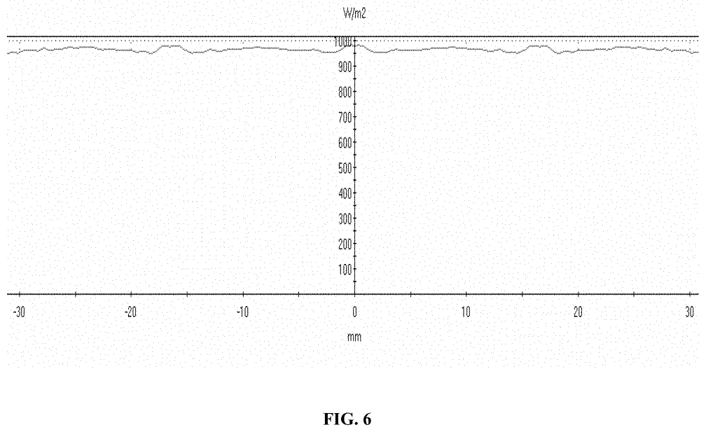

After the optical design is completed, Monte Carlo method is used to simulate the light, and the light energy distribution of 405 nm on the exposure screen is obtained (refer to FIG. 6), wherein, in the FIG. 6, the radiation flux of a single lens 1 W is used for optical simulation, and the power consumption of a single LED should be about 3 W; in the FIG. 6, the abscissa represents the energy of the light emitted by the LED of the irradiance curve at different positions of the whole spot, and the ordinate represents the energy values at different positions.

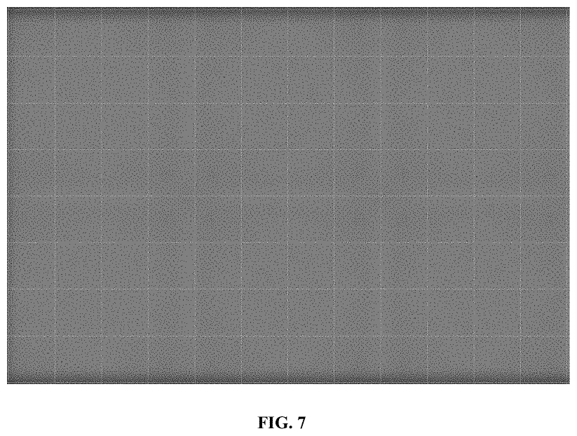

The light energy distribution on the whole exposure screen is more than 95% uniform (refer to FIG. 7); illuminance uniformity of exposure screen (monochrome LCD)=minimum illuminance value/average illuminance value, and the minimum illuminance value is calculated according to the point-by-point calculation method.

In order to further optimize the above technical scheme, 50% LED with light intensity angle of 60° or 90° is selected for UV ultraviolet LED chip.

This application is used to collect the light emitted by 50% LED with light intensity angle of 60° or 90° after passing through the corresponding first lens 211 and the second lens 221 in turn into parallel light or nearly parallel light energy with left-right angle less than 1.5 degrees (small light emitting angle).

In order to further optimize the above technical scheme, the circuit board 11 is an aluminum substrate or a copper substrate.

In order to further optimize the above technical scheme, the first matrix optical lens 21 and the second matrix optical lens 22 are biconvex matrix optical lenses; or, one of the first matrix optical lens 21 and the second matrix optical lens 22 is a plano-convex matrix optical lens and the other is a bi-convex matrix optical lens; or, one of the first matrix optical lens 21 and the second matrix optical lens 22 is a positive-moon matrix optical lens and the other is a biconvex matrix optical lens; or, one of the first matrix optical lens 21 and the second matrix optical lens 22, one is a biconvex matrix optical lens and the other is a plano-convex matrix optical lens; or, one of the first matrix optical lens 21 and the second matrix optical lens 22, one is a biconvex matrix optical lens and the other is a lunar matrix optical lens, or both the first matrix optical lens 21 and the second matrix optical lens 22 are lunar matrix optical lenses.

Embodiment 2: a 3D printer provided by the present disclosure uses the projection device with a combination matrix optical lens 2 as provided in embodiment 1, and the working principle is as follows:

1. UV ultraviolet LED chips emit light energy of 385˜405 nm, and UV ultraviolet LED chips choose 50% light intensity with an angle of 60 or 90 degrees;

2. The light energy passes through the lower plane of the corresponding first lens 211 (the side of the first lens 211 close to the corresponding UV ultraviolet LED chip is its lower plane), forms the first refraction and enters the corresponding first lens 211;

3. The light energy passes through about 8 mm and then is refracted out of the corresponding first lens 211, forming a first convergence, and then passes through the air, similarly, after entering the corresponding second lens 221, the light is refracted to form parallel light or near-parallel light having a left-right angle of less than 1.5 degrees (smaller light emitting angle). A uniform light energy distribution of 385-405 nm can be obtained on the LCD liquid crystal display 3 (the measured light machine uniformity reaches 90% or more), at the same time, the ability of light energy passing through the black-and-white LCD is improved (small-angle light energy is not easy to be partially blocked by black-and-white LCD, which is favorable for obtaining high light efficiency), so that the application can obtain higher light energy utilization rate.

4. Uniform parallel light or nearly parallel light with left-right angle less than 1.5 degrees (light emitting angle is small) is projected to the high-transparency black-and-white LCD liquid crystal display 3;

5. The unblocked light energy of 385 to 405 nm passes through the black and white LCD liquid crystal display 3 and enters the liquid resin box.

6. Light energy of 385-405 nm solidifies the numerical values of the same part of the liquid resin box to realize 3D printing function: the liquid value at the specified location becomes solid; the part not irradiated by 385˜405 nm light energy keeps the liquid resin unchanged. (Cooperate with lifting device to finish 3D object printing)

A 3D printer provided by the present disclosure uses the projection device with a combined matrix optical lens 2 as provided in the above embodiment 1, so that the LED light of 385-405 nm can be refracted to become precise parallel light with smaller angle, improve printing success rate and efficiency by using the 3D printer.

Wherein, the connection and positional relationship between the LCD screen 3 and the UV-curing 3D printer housing, the structure, position and connection mode of the liquid resin box, and other features (For example, the LED array 1, the first matrix optical lens 21, the radiator 5, the bracket 6 and the second matrix optical lens 22 are all located in the UV curing 3D printer housing) not mentioned in this application are all existing technologies, so they will not be repeated here.

In addition, the optical lens of this application is manufactured by using CNC ultra-precision processing and then ultra-precision injection molding.

In order to reduce the error of STP file conversion, the optical surface equation is used to manufacture the optical mold.

According to the different specifications and sizes of LCD panels in the industry, different customers have different requirements for energy and uniformity, and for the cost of light sources. We can reduce the number of LED units by as much as 35% to achieve higher light energy utilization by using double-sided optics to realize the same size screen.

At present, according to the UV-curing 3D printer industry, machines used in different fields have different requirements on the uniformity and energy of light source spot. For consumer machines, the general uniformity requirement is above 80% and the energy is above 3500 uW/CM. Consumer products have high requirements for cost control. At present, the largest single flat-convex matrix parallel light source in the industry can be less than 28 mm, and 28 mm per unit is the limit. In order to improve the cost performance of the light source, we now make the maximum lens less than 42 mm, so that the number of lenses used will be reduced and the cost will be reduced.

In this specification, each embodiment is described in a progressive way, and each embodiment focuses on the differences from other embodiments, so it is enough to refer to the same and similar parts between each embodiment. For the device disclosed in the embodiment, because it corresponds to the method disclosed in the embodiment, the description is relatively simple, and refer to the description of the method section for relevant information.

The above description of the disclosed embodiments enables those skilled in the art to realize or use the present disclosure. Many modifications to these embodiments will be obvious to those skilled in the art, and the general principles defined herein can be implemented in other embodiments without departing from the spirit or scope of the present disclosure. Therefore, the present disclosure will not be limited to the embodiments shown herein, but should be accorded the widest scope consistent with the principles and novel features disclosed herein.

1. A projection device with a combined matrix optical lens, comprising:
an LED array (1) arranged along a light path in sequence from bottom to top, the combined matrix optical lens (2), and an LCD liquid crystal display (3);
the LED array (1) comprises a plurality of rows and columns of point light sources (10), and the point light sources (10) are ultraviolet LED chips, each ultraviolet LED chip comprises an LED with 50% light intensity angle of 60° or 90°;
the combined matrix optical lens (2) comprises a first matrix optical lens (21) and a second matrix optical lens (22) arranged along an optical path in this order from bottom to top, wherein the first matrix optical lens (21) is composed of first lenses (211) with the same arrangement and the same number as the point light sources (10), the second matrix optical lens (22) is composed of second lenses (221) with the same arrangement and the same number as the point light sources (10), and a position of each point light source (10) coincides with a focal point of a corresponding first lens (211) and a corresponding second lens (221);
wherein 385-405 nm ultraviolet light emitted by each point light source (10) passes through the corresponding first lens (211) and the corresponding second lens (221) in turn and is projected to the LCD liquid crystal display (3);
wherein the LED array (1) further comprises a circuit board (11), and the plurality of the ultraviolet LED chips are all positioned on the circuit board (11);
the circuit board (11) is fixed on a radiator (5);
the first matrix optical lens (21) is connected to the radiator (5) and covers the circuit board (11) so as to be located above the plurality of the ultraviolet LED chips;
the radiator (5) is also connected with a bracket (6), the second matrix optical lens (22) is fixed on the bracket (6), and the bracket (6) is provided with a plurality of light holes (60), wherein the positions of the plurality of the light holes (60) correspond to the positions of the plurality of the first lenses (211), respectively, and also correspond to the positions of the plurality of the second lenses (221), respectively.

2. (canceled)

3. (canceled)

4. The device of claim 1, wherein the circuit board (11) is an aluminum substrate or a copper substrate.

5. A 3D printer, wherein the projection device with the combined matrix optical lens (2) of claim 1 is used in the 3D printer.
